(19) United States
(12) Patent Application Publication
(10) Pub. No.: US 2026/0208697 A1
(43) Pub. Date: Jul. 23, 2026

(54) VEHICULAR CABIN MONITORING SYSTEM WITH REAR WINDOW MONITORING

(71) Applicant: Magna Electronics Inc., Auburn Hills, MI (US)

(72) Inventors: Bharat Gnanasekaran, Farmington Hills, MI (US); Francis Judge, South Lyon, MI (US)

(21) Appl. No.: 19/452,988

(22) Filed: Jan. 20, 2026

Related U.S. Application Data
(60) Provisional application No. 63/747,942, filed on Jan. 22, 2025.

(51) Int. Cl. B60S 1/08; B60H 1/00; B60S 1/02; B60S 1/52; G06V 20/59

(52) U.S. Cl. CPC B60S 1/0844; B60H 1/00735; B60S 1/026; B60S 1/52; G06V 20/597

(57) ABSTRACT

A vehicular cabin monitoring system includes a camera that is disposed at an interior portion of an interior cabin of a vehicle and that views within the interior cabin of the vehicle. The camera views at least a portion of a rear window of the vehicle. Via processing of image data captured by the camera, the system monitors a driver of the vehicle and/or detects an occupant of the vehicle, and the system determines presence of an occlusion at the rear window of the vehicle. Responsive to determining presence of the occlusion, the system controls operation of a system of the vehicle to remove the occlusion from the rear window.

### CROSS REFERENCE TO RELATED APPLICATION

The present application claims the filing benefits of U.S. provisional application Ser. No. 63/747,942, filed Jan. 22, 2025, which is hereby incorporated herein by reference in its entirety.

### FIELD OF THE INVENTION

The present invention relates to the field of driver monitoring systems or occupant monitoring systems for vehicles.

### BACKGROUND OF THE INVENTION

It is known to provide a mirror assembly that is adjustably mounted to an interior portion of a vehicle, such as via a single or double ball pivot or joint mounting configuration where the mirror casing and mirror reflective element are adjusted relative to the interior portion of a vehicle by pivotal movement about the single or double ball pivot configuration. The mirror casing and reflective element are pivotable about one or two ball pivot joints by a user that is adjusting a rearward field of view of the reflective element.

### SUMMARY OF THE INVENTION

A vehicular cabin monitoring system includes an interior rearview mirror assembly including a mirror head adjustable about a mounting structure. The mounting structure is configured to mount the interior rearview mirror assembly at an interior portion of an interior cabin of a vehicle. The mirror head accommodates a mirror reflective element. A camera is accommodated by the mirror head, and, with the interior rearview mirror assembly mounted at the interior portion of the interior cabin of the vehicle, the camera views within the interior cabin of the vehicle. The camera and the mirror reflective element move together and in tandem with the mirror head when, with the interior rearview mirror assembly mounted at the interior portion of the interior cabin of the vehicle, the mirror head is adjusted about the mounting structure to provide a rearward view for a driver of the vehicle provided by the mirror reflective element. With the mirror head adjusted to provide the rearward view for the driver of the vehicle, the camera views at least a portion of a rear window of the vehicle. Image data captured by the camera is transferred to an electronic control unit (ECU). The ECU includes electronic circuitry and associated software, and the electronic circuitry of the ECU includes an image processor operable to process image data transferred to the ECU. With the interior rearview mirror assembly mounted at the interior portion of the interior cabin of the vehicle, and via processing at the ECU of image data captured by the camera, the vehicular cabin monitoring system determines presence of an occlusion at the rear window of the vehicle. Responsive to determining presence of the occlusion at the rear window of the vehicle, the vehicular cabin monitoring system controls operation of a system of the vehicle to remove or reduce the occlusion from the rear window of the vehicle. For example, the system may control operation of one or more of a heater grid, a wiper at the rear window, a washer fluid spray nozzle, a blower of an HVAC system, and the like. Image data captured by the camera may be processed for determining occlusions at the rear window and may be processed for a driver monitoring function and/or an occupant monitoring function and/or occupant detection function.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a driver monitoring system or occupant monitoring system;

FIG. 2 is a perspective view of an interior rearview mirror assembly having a cabin monitoring camera and a near infrared light emitter behind a reflective element of the interior rearview mirror assembly;

FIG. 3 is another perspective view of the interior rearview mirror assembly, showing the cabin monitoring camera and light emitters without the reflective element; and

FIG. 4 is a flowchart of an example method of operations for detecting occlusions at a rear window of the vehicle via processing of image data captured by the cabin monitoring camera.

### DESCRIPTION OF THE PREFERRED EMBODIMENTS

A driver of a vehicle may view reflections at an interior rearview mirror assembly to view rearward of the vehicle, such as when performing a reversing maneuver or to monitor traffic when travelling in a forward direction of travel. However, the rearview mirror may not provide adequate visibility rearward of the vehicle when a rear window of the vehicle is blocked, such as due to snow, ice, fog, rain, debris, and the like. Typically, the rear window is cleared by the driver on a need-basis, such as by manually activating a rear wiper to clear the rear window, by manually cleaning the window when the vehicle is not being operated, by manually activating a heater grid at the rear window, and the like. The rear view thus may become occluded or unavailable, impacting the driving experience. Further, improper use of the rear wiper, such as activating the rear wiper when there is a substantial amount of debris or ice, may cause damage to the wiper and/or fail to clear the occlusion (e.g., streaks may remain on the rear window). As discussed further below, a vehicular vision system or cabin monitoring system may process image data captured by a driver monitoring camera or an occupant monitoring camera (e.g., disposed at the interior rearview mirror assembly) to detect presence of occlusions at the rear window and control operation of one or more of a heater grid of the rear window, a rear wiper blade, a rear window wiper fluid pump, and the like, to clear the occlusions from the rear window and maintain a clear rearward view for the driver through the rear window.

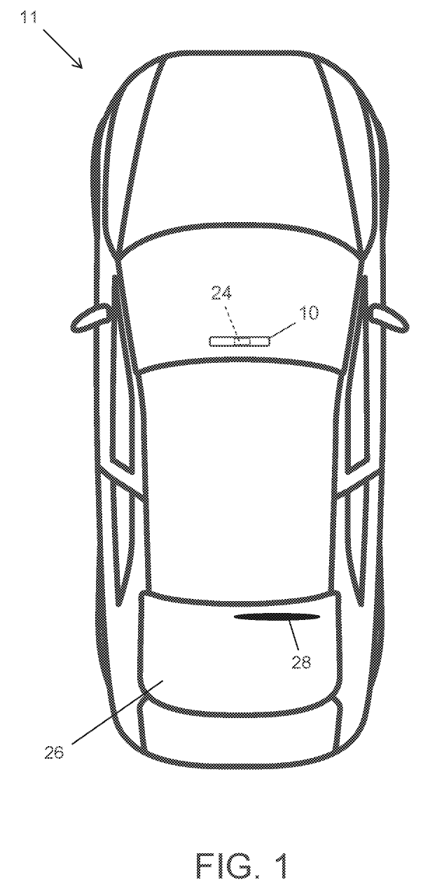

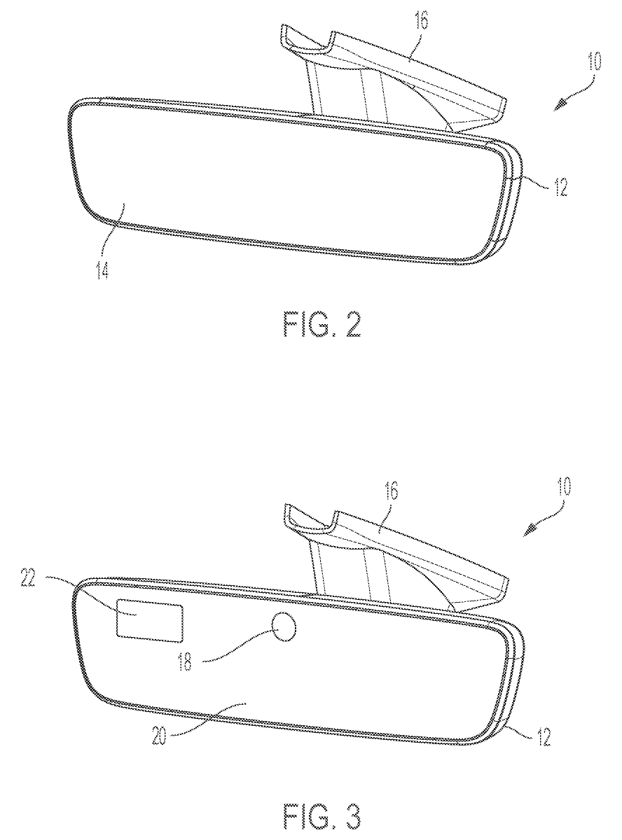

Referring now to the drawings and the illustrative embodiments depicted therein, an interior rearview mirror assembly 10 for a vehicle 11 includes a casing 12 and a reflective element 14 positioned at a front portion of the casing 12 (FIGS. 1 and 2). In the illustrated embodiment, the mirror assembly 10 is configured to be adjustably mounted to an interior portion of the vehicle 11 (such as to an interior or in-cabin surface of a vehicle windshield or a headliner of the vehicle or the like) via a mounting structure or mounting configuration or assembly or stay 16. The system includes a camera 18 disposed at and movable with the mirror head. For example, the camera 18 may be disposed behind the mirror reflective element 14 and view through the mirror reflective element 14 for capturing image data representative of the interior cabin of the vehicle, including the driver's head region and occupant region of the vehicle cabin. The system may utilize aspects of driver monitoring systems or occupant monitoring systems described in U.S. Pat. Nos. 11,930,264; 11,827,153; 11,780,372 and/or 11,639,134, and/or International Publication No. WO 2023/220222 and/or International Patent Application Ser. No. PCT/US25/038021, filed Jul. 17, 2025 (Attorney Docket DON01 FP5398W0), which are all hereby incorporated herein by reference in their entireties.

The mirror assembly 10 includes or is associated with a driver monitoring system (DMS), an occupant monitoring system (OMS) and/or a cabin monitoring system, with the mirror assembly 10 comprising the driver/occupant monitoring camera 18 disposed at a back plate 20 (and viewing through an aperture of the back plate) behind the reflective element 14 and viewing through the reflective element 14 toward at least a head region of the driver of the vehicle 11 (FIG. 3). That is, the driver monitoring camera 18 is accommodated by the mirror head, and with the mounting structure 16 attached at the interior portion of the cabin of the vehicle 11, the driver monitoring camera views within the cabin of the vehicle 11 toward at least the head region of the driver. The DMS may include an infrared light (IR light) or near infrared light (near IR light) emitter 22 disposed at the back plate and emitting IR light or near IR light that passes through another aperture of the back plate and through the reflective element 14.

Image data captured by the DMS/OMS camera 18 may be transferred to an electronic control unit (ECU) 24 that includes electronic circuitry and associated software, including an image processor for processing image data captured by the DMS/OMS camera 18. Although shown in FIG. 1 as disposed at the mirror assembly 10, the ECU 24 may be disposed remote from the mirror assembly 10 (e.g., a vehicle domain controller) and image data may be transferred from the DMS/OMS camera 18 to the remote ECU, such as via a coaxial cable. The image data captured by the camera 18 may be processed at the ECU 24 for DMS and/or OMS functions, such as for a head and face direction and position tracking system and/or eye tracking system and/or gesture recognition system. Moreover, the captured image data may be processed at the ECU 24 to determine if a rear window or tailgate window or liftgate window 26 of the vehicle 11 is blocked or occluded, such as by dirt or debris or ice or snow, which may reduce the driver's ability to view through the rear window 26 via reflections at the mirror reflective element 14.

Optionally, the DMS/OMS camera may be disposed at other portions of the interior cabin of the vehicle, such as at a windshield-mounted electronics module (WEM), at the mounting structure 16 of the mirror assembly, at the headliner of the vehicle, and the like, where the mounting position of the camera allows the camera to view the driver and/or one or more passengers of the vehicle and at least a portion of the rear window 26. Optionally, the camera may be disposed at other portions of the interior cabin of the vehicle, such as at a dashboard of the vehicle, a gauge cluster of the vehicle, a center stack of the vehicle, and the like. For example, the camera may view through an aperture formed through the portion of the interior cabin of the vehicle, or the camera may view through an at least partially light transmissive portion of a display screen within the interior cabin (e.g., at the gauge cluster or an infotainment screen at the center stack).

That is, the image data captured by the DMS/OMS camera 18 is processed to determine presence of occlusions at the rear window 26 and to control one or more systems of the vehicle 11 to remove or reduce the occlusions at the rear window 26. For example, the vehicle 11 may include a wiper 28 at the rear window 26 and, based on determination of occlusions at the rear window 26, the wiper 28 may be operated to clear the rear window 26, such as by spraying washer fluid onto the rear window 26 and/or moving a wiper blade across the exterior surface of the rear window 26. Further, the rear window 26 may include a heater grid that is operable to defrost or deice the rear window 26 responsive to detection of occlusions at the rear window 26, and/or a heating, ventilation and air conditioning (HVAC) system of the vehicle 11 may include a defroster or blower that directs airflow at the rear window 26 for defrosting or deicing the rear window 26 responsive to detection of occlusions at the rear window 26.

The image data captured by the camera 18 may be processed for both the DMS/OMS function and for detecting presence of occlusions at the rear window 26. For example, a first portion of the captured image data or frames of image data may correspond to the driver's head region, the front passenger region, a rear or second row passenger region and/or other regions of the interior cabin of the vehicle that are monitored for the DMS/OMS function, and a second portion of the captured image data or frames of image data may correspond to the rear window 26. The first portion of the captured image data may be processed for the DMS/OMS function and the second portion of the captured image data may be processed for detecting occlusions at the rear window 26. The first portion and the second portion of the image data may be determined based on a determined position of the mirror head (e.g., determined via a sensor that detects the position of the mirror head) and/or based on detecting one or more structures (e.g., the rear window) or objects or occupants (e.g., the driver of the vehicle or passengers of the vehicle) within the captured image data. Optionally, the first portion of the image data may be further segmented so that portions of this image data representative of the driver of the vehicle are processed for driver monitoring functions and portions of this image datarepresentative of occupants of the vehicle or objects within the vehicle are processed for occupant monitoring functions and/or cabin monitoring functions.

Further, the system may receive inputs or sensor data from one or more systems or sensors of the vehicle 11 for determining occlusions at the rear window 26, such as based on a temperature exterior the vehicle, a glare light sensor, a rain sensor, and/or other signals received via the vehicle communication network. The system may determine a type or classification of the occlusion at the rear window 26, such as differentiating between rain or moisture, ice, snow, dirt or debris, and the like. For example, image data captured by the camera may be processed to determine or identify the occlusion at the window. Moreover, the system may activate a first system of the vehicle to begin cleaning or removing the occlusion and, based on monitoring of the occlusion at the rear window 26 (such as via processing of image data captured by the camera) during cleaning, stop operating the first system and begin operating additional systems of the vehicle for further cleaning or removing of the occlusion.

For example, based on detecting occlusions at the rear window 26 and based on the temperature exterior the vehicle being below a threshold temperature (e.g., below 32 degrees Fahrenheit), the system may determine presence of ice or snow at the rear window and activate the heater grid at the rear window 26 and/or spray washer fluid onto the window 26 prior to operating the wiper 28. The wiper 28 may be activated based on determination (e.g., via processing of image data) that the snow or ice has at least partially melted. Based on the temperature being greater than the threshold temperature, and based on the rain sensor not indicating presence of rain (or based on determination that the occlusion is relatively still or not moving at the window), and/or in part via processing of image data captured by the camera, the system may determine presence of dirt or debris at the rear window 26 and spray washer fluid onto the window 26 prior to operating the wiper 28. Here, the wiper 28 may be operated based on determination that the wiper fluid has been sprayed onto the window 26. Based on the temperature being greater than the threshold temperature, and based on the rain sensor indicating presence of rain (or based on determination that the occlusion is moving at the window), and/or in part via processing of image data captured by the camera, the system may determine presence of rain or moisture at the window and may operate the wiper 28 to clear the rear window 26. Following a cleaning operation, the system may process image data to determine if the occlusion has been removed properly and, based on continued detection of the occlusion, the system may perform a cleaning operation again. Thus, the system may use an algorithm to detect the blockage or occlusion and to identify or classify the type of occlusion and provide a corresponding response to clear the rear window 26 directly (e.g., controlling operation of the rear wiper) or indirectly (e.g., operating the heater grid) by transmitting signals to the responsible ECU.

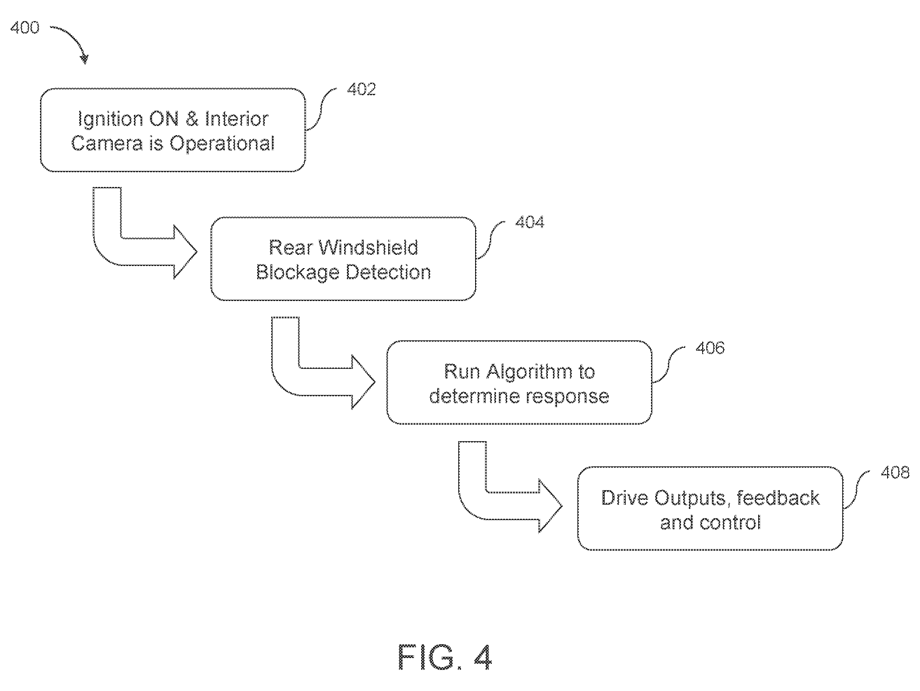

FIG. 4 depicts a flowchart of an example method 400 of operations for detecting presence of occlusions at the rear window 26 via processing of image data captured by the DMS/OMS camera 18. At operation 402, the method 400 includes turning the ignition of the vehicle 11 on (i.e., starting the vehicle to activate accessory systems and/or the propulsion system of the vehicle). Operation 402 may include determining that the vehicle battery state of charge is good and the interior camera 18 is operational. At operation 404, the method 400 includes detecting a blockage or occlusion at the rear window 26. Operation 404 may include detecting that the rear window 26 is blocked or has poor visibility via processing of the image data from the interior camera 18, and may further include classifying the occlusion as one or more of snow, ice, fog, rain, debris and the like. At operation 406, the method 400 includes running an algorithm to determine a response. That is, operation 406 may include determining a response or operation to clear the blockage and/or improve visibility based on processing of image data captured by the camera and classifying the determined occlusion and/or based on one or more inputs from the vehicle, including a temperature sensor, a rain sensor, a glare light sensor, and other vehicle signals. At operation 408, the method 400 includes driving outputs to clear the rear window 26, feedback and control. In other words, operation 408 may include clearing the rear window 26 by driving outputs directly or indirectly by sensing signals to the responsible ECU (e.g., for operating the heater grid or operating the wiper 28). The system monitors the feedback via the DMS/OMS camera 18 and may adjust or control the outputs accordingly (e.g., the system may switch from controlling the heater grid to controlling the rear wiper based on determination that the ice or snow is melting). This improves rear windshield visibility for the driver at all times and may improve the life of the wiper by triggering operation only in applicable situations. The system may utilize characteristics of the vehicular control systems described in U.S. Pub. No. 2022-0396242, which is hereby incorporated herein by reference in its entirety.

Optionally, the ECU 24 may process image data for the DMS/OMS function, may process image data for determining occlusions at the rear window 26 and controlling operation of one or more systems of the vehicle 11 for removing the occlusions, and the ECU 24 may include circuitry for controlling dimming of an electrochromic mirror reflective element of the mirror assembly. Further, image data captured by the DMS/OMS camera 18 may be processed for determining a level of ambient light at or near the mirror head and/or for detecting glare light incident at the mirror reflective element. The ECU and mirror assembly may utilize characteristics of the mirror assemblies and systems described in U.S. Pat. App. Ser. No. 19/369,638, filed Oct. 27, 2025 (Attorney Docket DON01 P5482), which is hereby incorporated herein by reference in its entirety.

The variably reflective mirror reflective element of the mirror assembly may utilize aspects of the mirror reflective elements described in commonly assigned U.S. Pat. Nos. 7,626,749; 7,274,501; 7,255,451; 7,195,381; 7,184,190; 6,690,268; 5,140,455; 5,151,816; 6,178,034; 6,154,306; 6,002,544; 5,567,360; 5,525,264; 5,610,756; 5,406,414; 5,253,109; 5,076,673; 5,073,012; 5,115,346; 5,724,187; 5,668,663; 5,910,854; 5,142,407 and/or 4,712,879, and/or U.S. Publication No. US-2022-0371513, which are hereby incorporated herein by reference in their entireties.

The DMS camera thus may be used to detect ambient light and/or glare light (emanating from headlamps of a trailing vehicle) for use in providing auto-dimming of the EC mirror reflective element. The processing of image data captured by the DMS camera may be adjusted to accommodate the angle of the mirror head so that the ECU or system, via image processing of image data captured by the DMS camera, determines headlamps of a trailing vehicle (behind the equipped vehicle and traveling in the same direction as the equipped vehicle and traveling in the same traffic lane or in an adjacent traffic lane) to determine glare light incident at the mirror reflective element. Optionally, image data captured by another rearward-viewing camera, such as a rear backup camera of the vehicle or a higher-mounted (e.g., CHMSL mounted) rearward-viewing camera at or near a center high-mounted stop lamp of the vehicle, may be processed for determining ambient light and glare light. The processing of image data captured by the DMS camera is adjusted to accommodate the degree of dimming of the mirror reflective element. For example, the system knows how much the mirror reflective element is dimmed (responsive to the determined glare light intensity and location) and can accommodate for the mirror dimming level when processing captured image data to determine presence and intensity of light sources / headlamps rearward of the vehicle. The intelligent / automatic mirror dimming functions may utilize aspects of the systems described in U.S. Pat. Nos. 11,780,372; 11,242,008; 10,967,796 and/or 10,948,798, and/or U.S. Publication No. US- 2024-0064274, which are all hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640 x 480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red / red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014- 0347486; US-2014-0320658; US-2014-0336876; US-2014-0307095; US-2014-0327774; US-2014-0327772; US-2014-0320636; US-2014-0293057; US-2014-0309884; US-2014- 0226012; US-2014-0293042; US-2014-0218535; US-2014-0218535; US-2014-0247354; US-2014-0247355; US-2014-0247352; US-2014-0232869; US-201 4-0211009; US-2014- 0160276; US-2014-0168437; US-2014-0168415; US-2014-0160291; US-2014-0152825; US-2014-0139676; US-2014-0138140; US-2014-0104426; US-2014-0098229; US-2014- 0085472; US-2014-0067206; US-2014-0049646; US-2014-0052340; US-2014-0025240; US-2014-0028852; US-2014-005907; US-2013-0314503; US-2013-0298866; US-2013- 0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may utilize aspects of driver monitoring systems and/or head and face direction and position tracking systems and/or eye tracking systems and/or gesture recognition systems. Such head and face direction and/or position tracking systems and/or eye tracking systems and/or gesture recognition systems may utilize aspects of the systems described in U.S. Pat. Nos. 11,827,153; 11,780,372; 11,639,134; 11,582,425; 11,518,401; 10,958,830; 10,065,574; 10,017,114; 9,405,120 and/or 7,914,187, and/or U.S. Publication Nos. US-2024-0383406; US-2024-0190456; US-2024-0168355; US-2022- 0377219; US-2022-0254132; US-2022-0242438; US-2021-0323473; US-2021-0291739; US-2020-0320320; US-2020-0202151; US-2020-0143560; US-2019-0210615; US-2018- 0231976; US-2018-0222414; US-2017-0274906; US-2017-0217367; US-2016-0209647; US-2016-0137126; US-2015-0352953; US-2015-0296135; US-2015-0294169; US-2015- 0232030; US-2015-0092042; US-2015-0022664; US-2015-0015710; US-2015-0009010 and/or US-2014-0336876, and/or International Publication Nos. WO 2023/220222 and/or WO 2025/231198 and/or International Patent Application Ser. No. PCT/US25/038021, filed Jul. 17, 2025 (Attorney Docket DON01 FP5398W0), which are all hereby incorporated herein by reference in their entireties.

The interior-viewing camera may be disposed at the mirror head of the interior rearview mirror assembly and moves together and in tandem with the mirror head when the driver of the vehicle adjusts the mirror head to adjust his or her rearward view. The interior-viewing camera may be disposed at a lower or chin region of the mirror head below the mirror reflective element of the mirror head, or the interior-viewing camera may be disposed behind the mirror reflective element and viewing through the mirror reflective element. Similarly, the light emitter may be disposed at the lower or chin region of the mirror head below the mirror reflective element of the mirror head (such as to one side or the other of the interior-viewing camera), or the light emitter may be disposed behind the mirror reflective element and emitting light that passes through the mirror reflective element. The ECU may be disposed at the mirror assembly (such as accommodated by the mirror head), or the ECU may be disposed elsewhere in the vehicle remote from the mirror assembly, whereby image data captured by the interior-viewing camera may be transferred to the ECU via a coaxial cable or other suitable communication line. Cabin monitoring or occupant detection may be achieved via processing at the ECU of image data captured by the interior-viewing camera. Optionally, cabin monitoring or occupant detection may be achieved in part via processing at the ECU of radar data captured by one or more interior-sensing radar sensors disposed within the vehicle and sensing the interior cabin of the vehicle.

The coaxial cable provides bi-directional communication between the mirror head and the ECU that is located at the vehicle remote from the mirror head. For example, the coaxial cable may provide power from the ECU to the mirror head and may provide control signals or data to the mirror head, and may receive image data from the camera at the mirror head. The coaxial cable and electronic connection between the ECU and the mirror head may utilize aspects of the systems described in U.S. Pat. Nos. 10,567,705; 10,298,823; 10,099,614; 10,089,537; 9,900,490 and/or 9,609,757, which are hereby incorporated herein by reference in their entireties. Thus, the bi-directional coaxial cable may commonly carry (i) image data captured by the DMS camera from the mirror head to the ECU, (ii) control signals from the ECU to the mirror head (such as for controlling the camera and/or a light emitter and/or dimming circuitry of the mirror head), and (iii) electrical power from a DC power supply of (or connected to) the ECU to the mirror head.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular cabin monitoring system, the vehicular cabin monitoring system comprising:a camera disposed at an interior portion of an interior cabin of a vehicle, wherein the camera views within the interior cabin of the vehicle;wherein the camera views at least a portion of a rear window of the vehicle;an electronic control unit (ECU);wherein image data captured by the camera is transferred to the ECU;wherein the ECU comprises electronic circuitry and associated software, and wherein the electronic circuitry of the ECU comprises an image processor operable to process image data transferred to the ECU;wherein, via processing at the ECU of image data captured by the camera, the vehicular cabin monitoring system at least one selected from the group consisting of (i) monitors a driver of the vehicle and (ii) detects an occupant of the vehicle;wherein, via processing at the ECU of image data captured by the camera, the vehicular cabin monitoring system determines presence of an occlusion at the rear window of the vehicle; andwherein, responsive to determining presence of the occlusion at the rear window of the vehicle, the vehicular cabin monitoring system controls operation of a system of the vehicle to remove the occlusion from the rear window of the vehicle.

2. The vehicular cabin monitoring system of claim 1, wherein the vehicular cabin monitoring system controls operation of a wiper at the rear window of the vehicle to remove the occlusion from the rear window of the vehicle.

3. The vehicular cabin monitoring system of claim 2, wherein the vehicular cabin monitoring system operates the wiper to remove the occlusion from the rear window of the vehicle responsive to determination that the occlusion comprises rain or moisture.

4. The vehicular cabin monitoring system of claim 3, wherein the vehicular cabin monitoring system determines that the occlusion comprises rain or moisture based at least in part on a signal received from a rain sensor of the vehicle.

5. The vehicular cabin monitoring system of claim 1, wherein the vehicular cabin monitoring system controls operation of a heater grid at the rear window of the vehicle to remove the occlusion from the rear window of the vehicle.

6. The vehicular cabin monitoring system of claim 5, wherein the vehicular cabin monitoring system operates the heater grid to remove the occlusion from the rear window of the vehicle responsive to determination that the occlusion comprises snow or ice.

7. The vehicular cabin monitoring system of claim 6, wherein the vehicular cabin monitoring system determines that the occlusion comprises snow or ice based at least in part on a signal received from a temperature sensor of the vehicle.

8. The vehicular cabin monitoring system of claim 5, wherein, responsive to operation of the heater grid, and based on determination of moisture at the rear window of the vehicle, the vehicular cabin monitoring system controls operation of a wiper at the rear window of the vehicle to remove the moisture from the rear window of the vehicle.

9. The vehicular cabin monitoring system of claim 1, wherein the vehicular cabin monitoring system controls operation of a heating, ventilation and air conditioning (HVAC) system of the vehicle to remove the occlusion from the rear window of the vehicle.

10. The vehicular cabin monitoring system of claim 1, wherein the vehicular cabin monitoring system controls operation of a washer fluid nozzle to spray washer fluid onto the rear window of the vehicle to remove the occlusion from the rear window of the vehicle.

11. The vehicular cabin monitoring system of claim 10, wherein the vehicular cabin monitoring system operates the washer fluid nozzle to remove the occlusion from the rear window of the vehicle responsive to determination that the occlusion comprises debris.

12. The vehicular cabin monitoring system of claim 10, wherein, responsive to operation of the washer fluid nozzle, and based on determination of washer fluid at the rear window of the vehicle, the vehicular cabin monitoring system controls operation of a wiper at the rear window of the vehicle to remove the washer fluid from the rear window of the vehicle.

13. The vehicular cabin monitoring system of claim 1, wherein (i) a first portion of image data captured by the camera is processed at the ECU for the at least one of monitoring the driver of the vehicle and detecting the occupant of the vehicle and (ii) a second portion of image data captured by the camera is processed at the ECU for determining presence of the occlusion at the rear window of the vehicle.

14. The vehicular cabin monitoring system of claim 1, wherein the rear window is disposed at a liftgate of the vehicle.

15. A vehicular cabin monitoring system, the vehicular cabin monitoring system comprising:an interior rearview mirror assembly comprises a mirror head adjustable about a mounting structure, wherein the mounting structure is configured to mount the interior rearview mirror assembly at an interior portion of an interior cabin of a vehicle;wherein the mirror head accommodates a mirror reflective element;wherein a camera is accommodated by the mirror head, and wherein, with the interior rearview mirror assembly mounted at the interior portion of the interior cabin of the vehicle, the camera views within the interior cabin of the vehicle;wherein the camera and the mirror reflective element move together and in tandem with the mirror head when, with the interior rearview mirror assembly mounted at the interior portion of the interior cabin of the vehicle, the mirror head is adjusted about the mounting structure to provide a rearward view for a driver of the vehicle;wherein, with the interior rearview mirror assembly mounted at the interior portion of the interior cabin of the vehicle, and with the mirror head adjusted such that the mirror reflective element provides the rearward view for a driver of the vehicle, the camera views at least a portion of a rear window of the vehicle;
wherein the rear window is disposed at a liftgate of the vehicle, and wherein a wiper is disposed at the rear window;
an electronic control unit (ECU);
wherein image data captured by the camera is transferred to the ECU;
wherein the ECU comprises electronic circuitry and associated software, and wherein the electronic circuitry of the ECU comprises an image processor operable to process image data transferred to the ECU;
wherein, with the interior rearview mirror assembly mounted at the interior portion of the interior cabin of the vehicle, and via processing at the ECU of image data captured by the camera, the vehicular cabin monitoring system at least one selected from the group consisting of (i) monitors a driver of the vehicle and (ii) detects an occupant of the vehicle;
wherein, with the interior rearview mirror assembly mounted at the interior portion of the interior cabin of the vehicle, and via processing at the ECU of image data captured by the camera, the vehicular cabin monitoring system determines presence of an occlusion at the rear window of the vehicle; and
wherein, responsive to determining presence of the occlusion at the rear window of the vehicle, the vehicular cabin monitoring system controls operation of a washer fluid nozzle to spray washer fluid onto the rear window and the vehicular cabin monitoring system controls operation of the wiper at the rear window of the vehicle to remove the occlusion from the rear window of the vehicle.

16. The vehicular cabin monitoring system of claim 15, wherein the vehicular cabin monitoring system operates the washer fluid nozzle to remove the occlusion from the rear window of the vehicle responsive to determination that the occlusion comprises debris.

17. The vehicular cabin monitoring system of claim 15, wherein the vehicular cabin monitoring system controls operation of the wiper at the rear window of the vehicle responsive to determination of washer fluid at the rear window of the vehicle.

18. A vehicular cabin monitoring system, the vehicular cabin monitoring system comprising:
an interior rearview mirror assembly comprises a mirror head adjustable about a mounting structure, wherein the mounting structure is configured to mount the interior rearview mirror assembly at an interior portion of an interior cabin of a vehicle;
wherein the mirror head accommodates a mirror reflective element;
wherein a camera is accommodated by the mirror head, and wherein, with the interior rearview mirror assembly mounted at the interior portion of the interior cabin of the vehicle, the camera views within the interior cabin of the vehicle;
wherein the camera and the mirror reflective element move together and in tandem with the mirror head when, with the interior rearview mirror assembly mounted at the interior portion of the interior cabin of the vehicle, the mirror head is adjusted about the mounting structure to provide a rearward view for a driver of the vehicle;
wherein, with the interior rearview mirror assembly mounted at the interior portion of the interior cabin of the vehicle, and with the mirror head adjusted such that the mirror reflective element provides the rearward view for a driver of the vehicle, the camera views at least a portion of a rear window of the vehicle;
an electronic control unit (ECU);
wherein image data captured by the camera is transferred to the ECU;
wherein the ECU comprises electronic circuitry and associated software, and wherein the electronic circuitry of the ECU comprises an image processor operable to process image data transferred to the ECU;
wherein, with the interior rearview mirror assembly mounted at the interior portion of the interior cabin of the vehicle, and via processing at the ECU of image data captured by the camera, the vehicular cabin monitoring system at least one selected from the group consisting of (i) monitors a driver of the vehicle and (ii) detects an occupant of the vehicle;
wherein, with the interior rearview mirror assembly mounted at the interior portion of the interior cabin of the vehicle, and via processing at the ECU of image data captured by the camera, the vehicular cabin monitoring system determines presence of an occlusion at the rear window of the vehicle;
wherein, responsive to determining presence of the occlusion at the rear window of the vehicle, and responsive to determination that the occlusion comprises rain or moisture, the vehicular cabin monitoring system controls operation of a wiper at the rear window to remove the rain or moisture from the rear window of the vehicle; and
wherein, responsive to determining presence of the occlusion at the rear window of the vehicle, and responsive to determination that the occlusion comprises snow or ice, the vehicular cabin monitoring system controls operation of a heater grid at the rear window to remove the snow or ice from the rear window of the vehicle.

19. The vehicular cabin monitoring system of claim 18, wherein the vehicular cabin monitoring system determines that the occlusion comprises rain or moisture based at least in part on a signal received from a rain sensor of the vehicle.

20. The vehicular cabin monitoring system of claim 18, wherein, responsive to operation of the heater grid, and based on determination of moisture at the rear window of the vehicle, the vehicular cabin monitoring system controls operation of the wiper at the rear window of the vehicle to remove the moisture from the rear window of the vehicle.
